(19) United States
(12) Patent Application Publication
(10) Pub. No.: US 2014/0068469 A1
(43) Pub. Date: Mar. 6, 2014

(54) MOBILE APPARATUS AND METHOD FOR TRANSFERRING INFORMATION

(71) Applicant: Pantech Co., Ltd., Seoul (KR)

(72) Inventor: Yeon Moon LEE, Seoul (KR)

(73) Assignee: Pantech Co., Ltd., Seoul (KR)

(21) Appl. No.: 14/017,429

(22) Filed: Sep. 4, 2013

(30) Foreign Application Priority Data
Sep. 4, 2012 (KR) 10-2012-0097779

(51) Int. Cl. G06F 3/0486

(52) U.S. Cl. CPC G06F 3/0486
USPC 715/761

(57) ABSTRACT

A mobile apparatus and a method for transferring information are disclosed. The mobile apparatus includes: a display to display a connection interface object in a first area of the display, the connection interface object connected with an external device, and to display a transferable object in a second area of the display, the connection interface object being configured to receive the transferable object; an input unit to identify an input associated with the connection interface object displayed on the display; and a communication unit to establish a wireless communication channel with the external device, and to transmit or receive data to or from the external device via the established wireless communication channel according to the input, the data including the transferable object received in the connection interface object.

### CROSS-REFERENCE TO RELATED APPLICATIONS

This application claims priority from and the benefit under 35 U.S.C.§119(a) of Korean Patent Application No. 10-2012-0097779, filed on Sep. 4, 2012, which is hereby incorporated by reference in its entirety for all purposes as if fully set forth herein.

### BACKGROUND

1. Field

The present disclosure relates to a mobile apparatus and a method for transferring information. More particularly, the present disclosure relates to a mobile apparatus that transfers information using a near field communication technology and a method thereof.

2. Discussion of the Background

Various methods for information transmission between mobile apparatuses of is different types have been introduced in accordance with developments of various wireless communication technologies. New technologies mainly focus on the improvement of transmission speed, and, for example, there are representative technologies, such as Bluetooth® 3.0, WI-FI Direct™, and Wireless USB. FIG. 1 is a flowchart illustrating an information transferring method based on a Bluetooth® technology according to the related art. Referring to FIG. 1, in order to use Bluetooth® technology, a Bluetooth® application is executed in a mobile apparatus 101 in operation S1. In operation S2, an apparatus 201 for which Bluetooth® transmission may be performed is searched for and is selected. In operation S3, a random number is generated. In operation S4, the random number is transmitted to the apparatus 201, and a connection is requested. In operation S5, the random number is checked in the apparatus 201, a transmission target mobile apparatus, and the connection request is approved. In operation S6, a connection is made through Bluetooth® protocol. In operation S7, a content transmission application is executed. In operation S8, a content to be transmitted is selected. In operation S9, the transmission of the selected content to the transmission target mobile apparatus 201 is requested. In operation S10, the transmission target mobile apparatus 201 approves the transmission. In operation S11, the content is transmitted to the transmission target mobile apparatus 201. As illustrated above, although the hardware technology has been developed, user experiences for information transmission are mainly designed from the viewpoint of the transmission technology, for example, applications are driven in many processes, and accordingly, the user experiences are complicated. In addition, it may not be easy for users using mobile apparatuses to use the transmission and reception function without the manipulation knowledge of wireless transmission technology. Accordingly, there are many instances in which such communication technologies are neglected or not utilized by users.

### SUMMARY

Exemplary embodiments of the present invention provide a mobile apparatus and a method for providing a user interface for transferring data via wireless communication.

Additional features of the invention will be set forth in the description which follows, and in part will be apparent from the description, or may be learned by practice of the invention.

Exemplary embodiments of the present invention provide a mobile apparatus, including: a display to display a connection interface object in a first area of the display, the connection interface object connected with an external device, and to display a transferable object in a second area of the display, the connection interface object being configured to receive the transferable object; an input unit to identify an input associated with the connection interface object displayed on the display; and a communication unit to establish a wireless communication channel with the external device, and to transmit or receive data to or from the external device via the established wireless communication channel according to the input, the data including the transferable object received in the connection interface object.

Exemplary embodiments of the present invention provide a method for transferring data via a connection interface object, the method including: displaying the connection interface object connected with an external device in a first area of a display, and displaying a transferable object in a second area of the display, the connection interface object being configured to receive the transferable object; identifying an input associated with the connection interface object displayed on the display; establishing a wireless communication channel with the external device; and transmitting or receiving data to or from the external device via the established wireless communication channel according to the input, the data including the transferable object received in the connection interface object.

Exemplary embodiments of the present invention provide a method for transferring data via a connection interface object, the method including: displaying a first connection interface object and a transferable object on a display, the first connection interface object being configured to receive the transferable object and being connected with a second connection interface object displayed on an external device; identifying an input associated with the first connection interface object displayed on the display; establishing a short range wireless communication channel with the external device, the first connection interface object and the second connection interface object being connected by the short range wireless communication channel; and transmitting or receiving data to or from the external device via the established short range wireless communication channel according to the input, the data including the transferable object and the transferable object being received in the first connection interface object from a portion of the display or from the second connection interface object.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating an information transferring method utilizing a Bluetooth® technology according to the related art.

FIG. 2A is a flowchart illustrating an information transferring method of a mobile apparatus according to an exemplary embodiment of the present invention.

FIG. 2B is a flowchart illustrating an information transferring method of a mobile apparatus according to an exemplary embodiment of the present invention.

FIG. 3A, FIG. 3B, FIG. 3C, FIG. 3D, FIG. 3E, and FIG. 3F are diagrams illustrating an information transfer process of a mobile apparatus according to an exemplary embodiment of the present invention.

FIG. 4A, FIG. 4B, FIG. 4C, and FIG. 4D are diagrams illustrating an information transfer process of a mobile apparatus according to an exemplary embodiment of the present invention.

FIG. 5A and FIG. 5B are diagrams illustrating an information transfer process of a mobile apparatus according to an exemplary embodiment of the present invention.

FIG. 6 is a diagram illustrating a configuration of a mobile apparatus according to an exemplary embodiment of the present invention.

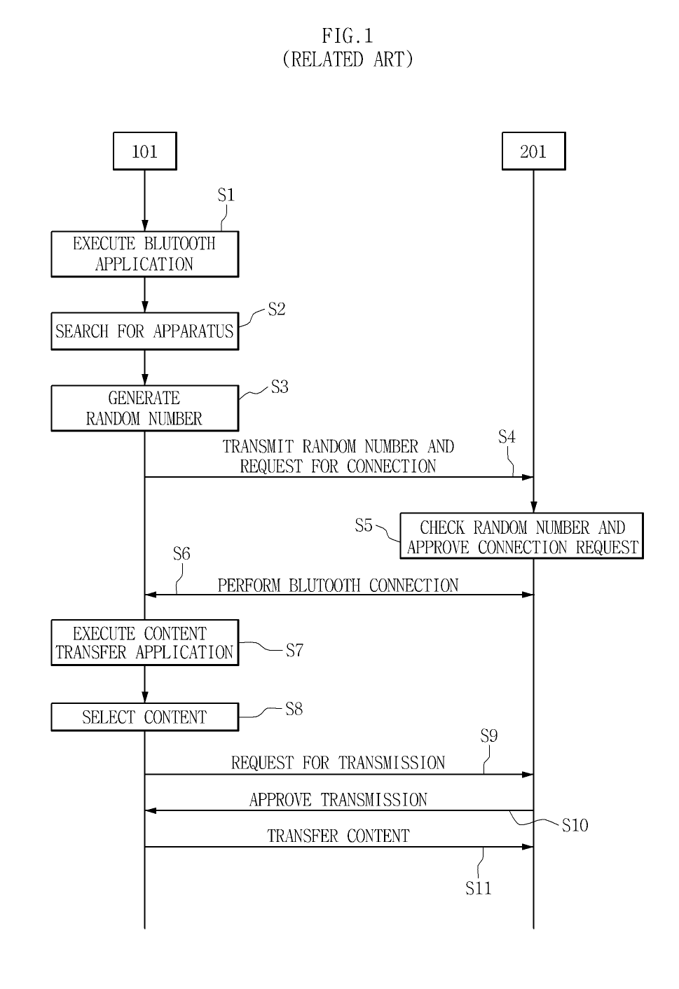

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The mobile apparatus described herein may be implemented in various forms and may include various features. The mobile apparatus may include an apparatus in which a specific application program can operate, and the type of the program is not limited to a specific form. Particularly, the mobile apparatus may be a smartphone that includes a display, a touch sensor, a motion sensor, a vibrator, a speaker, a communication module, and the like, a small-size smart pad, a tablet computer that provides a touch-based graphical user interface, etc.

The mobile apparatus may include a processing system that includes a processor, an operating system, and an application program interface (API) and provides communications between one or more application programs and operating system.

The processing system of the mobile apparatus may be configured to execute various application programs. The mobile apparatus may communicate with another object and include hardware or software mounted therein for such communications.

The communication method used in the mobile apparatus may include communication methods capable of networking an object with another object, and the method used for the communication function is not limited to a specific communication type, such as wired communication, wireless communication, 3^{rd} Generation (3G) mobile communication, 4^{th} Generation (4G) mobile communication, or the like. The information that can be transmitted and received, which includes various kinds of sensor information, audio information, and data information of the inside of the mobile apparatus, may be transmitted to or received from an external device through the mobile apparatus.

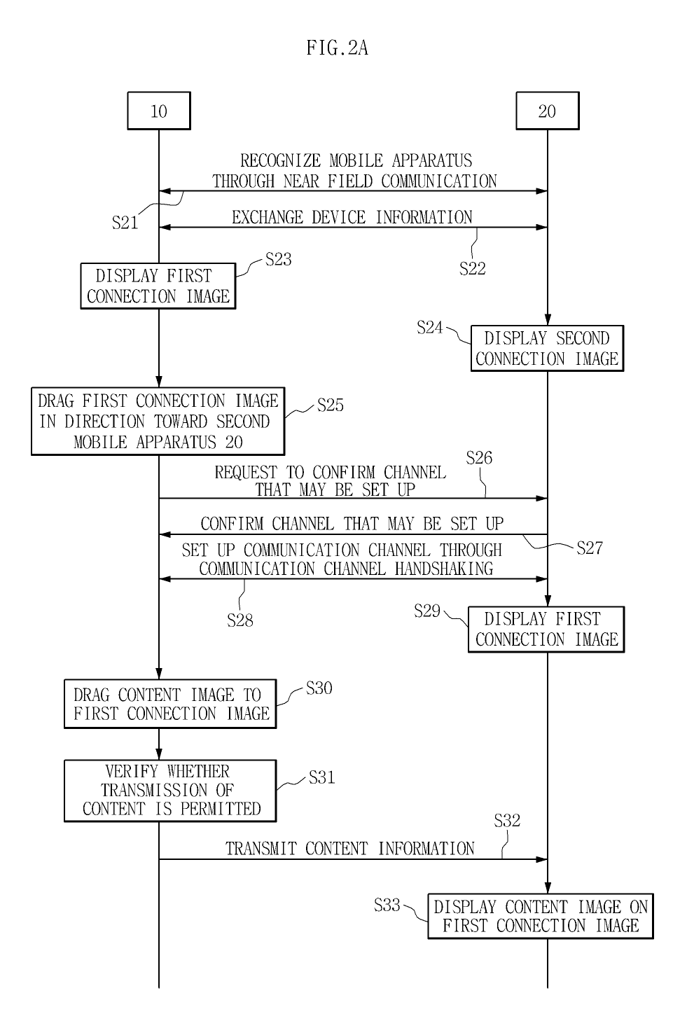

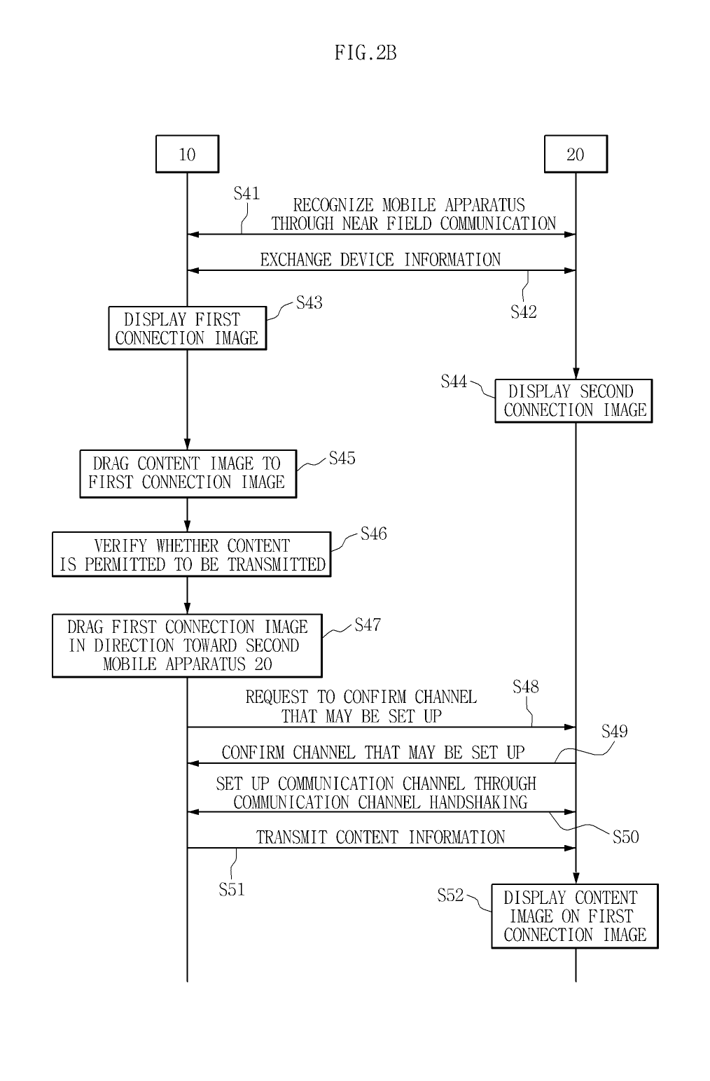

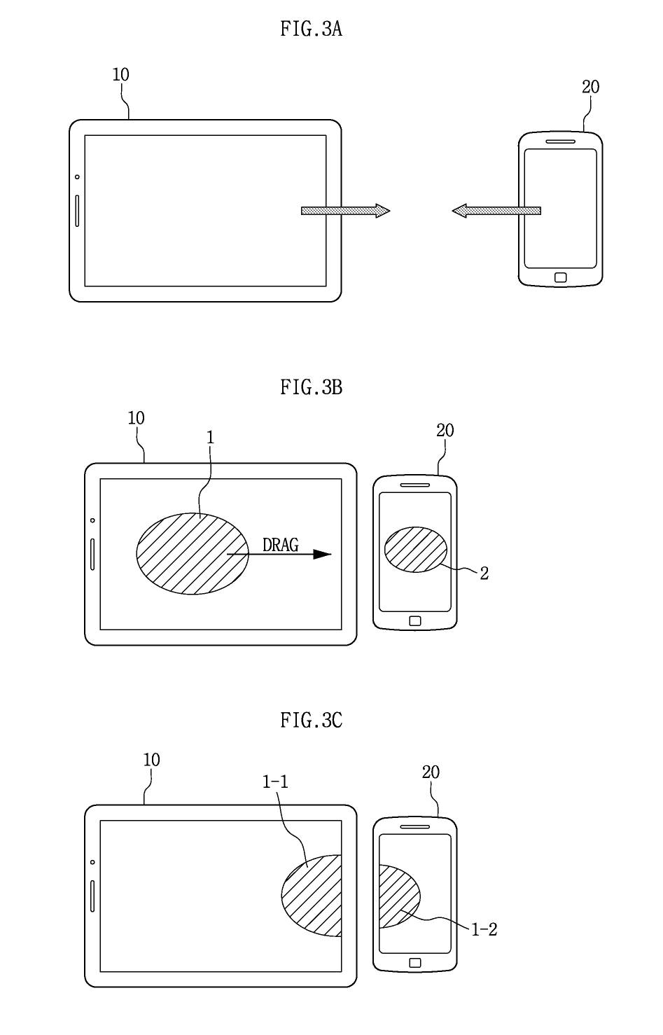

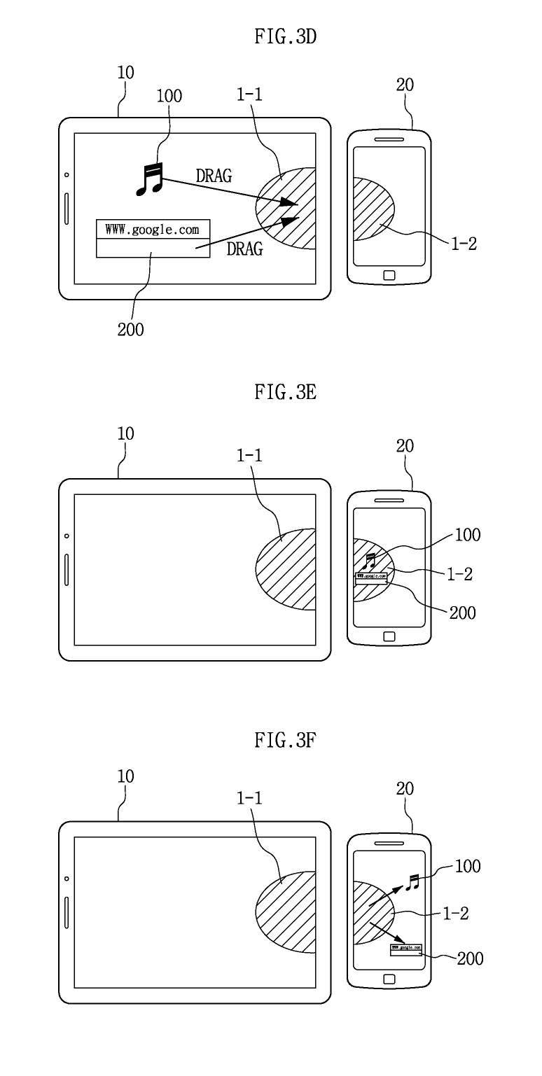

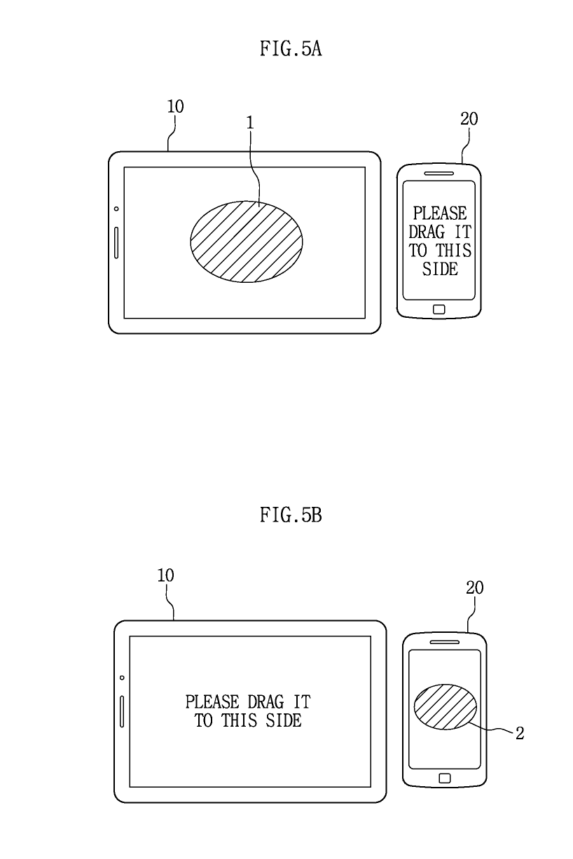

FIG. 2A is a flowchart illustrating an information transferring method of a mobile apparatus according to an exemplary embodiment of the present invention. FIG. 3A, FIG. 3B, FIG. 3C, FIG. 3D, FIG. 3E, and FIG. 3F are diagrams illustrating an information transfer process of a mobile apparatus according to an exemplary embodiment of the present invention. The information transferring method of the mobile apparatus will be described with reference to FIG. 3A to 3F. If a first mobile apparatus 10 and a second mobile apparatus 20 are located in close proximity to each other capable of a short range communication (for example, within 10 cm) in which a first communication unit 11 of the first mobile apparatus 10 is capable of performing a short range communication, e.g., a near field communication, with the second mobile apparatus 20 (See FIG. 3A), the device information of the first mobile apparatus 10 and the device information of the second mobile apparatus 20 may be exchanged. The exchanged device information may include communication profile information, device feature information, and display setting information. The communication profile information is information of a profile that is used for communications with other devices, and the device feature information is device-specific information, such a type of the device, device specification, and the like. The display setting information may include information that is used for a screen display, such as display resolution information, the number of pixels per inch, and the length of an adjoining face (inch). The first mobile apparatus 10 and the second mobile apparatus 20, as illustrated in FIG. 3B, display graphic user interfaces on display units 12 of the first mobile apparatus 10 and the second mobile apparatus 20, respectively. Although any graphic user interface may be used that provides a visual effect, an image illustrated in FIG. 3B will be described as an example. More specifically, the first mobile apparatus 10 and the second mobile apparatus 20, as illustrated in FIG. 3B, display connection images on the display units 12 (operation S23 and S24 in FIG. 2A). The display connection image or a connection image may refer to a graphical user interface that serves to perform transmission of data associated with the display connection image among multiple display connection images displayed in communication apparatuses. The shapes and the sizes of the images may be determined in advance and are not limited to a specific form. Further, as illustrated in FIG. 3B, a first connection image 1 displayed in the first mobile apparatus 10 may be dragged in a direction toward the second mobile apparatus 20. FIG. 5A and FIG. 5B are diagrams illustrating an information transfer process of a mobile apparatus according to an exemplary embodiment of the present invention. For example, as illustrated in FIGS. 5A and 5B, a user may be informed to drag the connection image by displaying drag request information, e.g., “Please drag it to this side!” in a display unit of another mobile apparatus for receiving a content. It may be configured such that, when the first connection image 1 is touched, a second connection image 2 is switched to display drag request information, e.g., “Please drag it to this side!” as illustrated in FIG. 5A, and a content information transmitting mode is set in the mobile apparatus 10. When the second connection image 2 is touched, as illustrated in FIG. 5B, the first connection image 1 is switched to display drag request information, e.g., “Please drag the image to this side!”, and a content information receiving mode is set in the mobile apparatus 10. In an example, the content information transmitting mode may be set as a master mode, and the content information receiving mode may be set as a slave mode. Further, when the first connection image 1 is dragged, the second connection image 2 may not be displayed or move together in a direction toward the first connection image 1. At this time, the first mobile apparatus 10 requests the second mobile apparatus 20 to confirm a communication channel that may be set up (operation S26 in FIG. 2A). The communication channel may include a Near Field Communication (NFC), Bluetooth® 3.0, WI-FI Direct™, and Wireless USB, but is not limited thereto. If the second mobile apparatus 20 confirms the communication channel that may be set up (operation S27), a communication channel is set up through communication channel handshaking based on the device information, e.g., the communication profile information (operation S28). The setting up of a communication channel, as illustrated in FIG. 3C, may be represented by displaying a part 1-1 of the first connection image in the first mobile apparatus 10 and displaying the other part 1-2 of the first connection image in the second mobile apparatus 20. Thereafter, as illustrated in FIG. 3D, content images 100 and 200 are dragged to the part 1-1 of the first connection image of the first mobile apparatus 10 (operation S30). The content images 100 and 200 are images corresponding to content information. If the is content images 100 and 200 are moved from the first mobile apparatus 10 to the second mobile apparatus 20, actual content information is copied or moved from the first mobile apparatus 10 to the second mobile apparatus 20. The content may include a document, an image, a video, a music file, or a folder, but is not limited thereto. Further, the content may include a screen 200 of a specific web page. In the case of the screen of a specific web page, after the address of a specific web page is transmitted to the second mobile apparatus 20 and a browser application is operated, by inputting the received address of the specific web page, the screen of the specific web page may be transferred to the mobile apparatus 20. It may be verified whether selected content is permitted to be transmitted before transmitting the selected content (operation S31). If digital rights management (DRM) is set in the content, a content producer may prohibit the replication of the content so as to protect the copyright thereof. A user may set a security setting for limiting the transmission of a specific content of the mobile apparatus. For example, the mobile apparatuses 10 and 20 may be configured to determine whether the transmission of content is permitted, and only permitted content may be transmitted. Further, a passcode or other types of authentication may be requested when the content transmission between mobile apparatuses 10 and 20 is attempted. The content information is transmitted through the communication channel that has been set up (operation S32). The content may be copied or moved to another mobile apparatus as described above by using graphical user interfaces that indicate wireless communication channel establishment among multiple apparatuses in a visual form. The transmitted contents 100 and 200, as illustrated in FIG. 3E, may be displayed in the other part 1-2 of the first connection image displayed in the second mobile apparatus 20 or be displayed in a part other than the other part 1-2 of the first connection image, as illustrated in FIG. 3F.

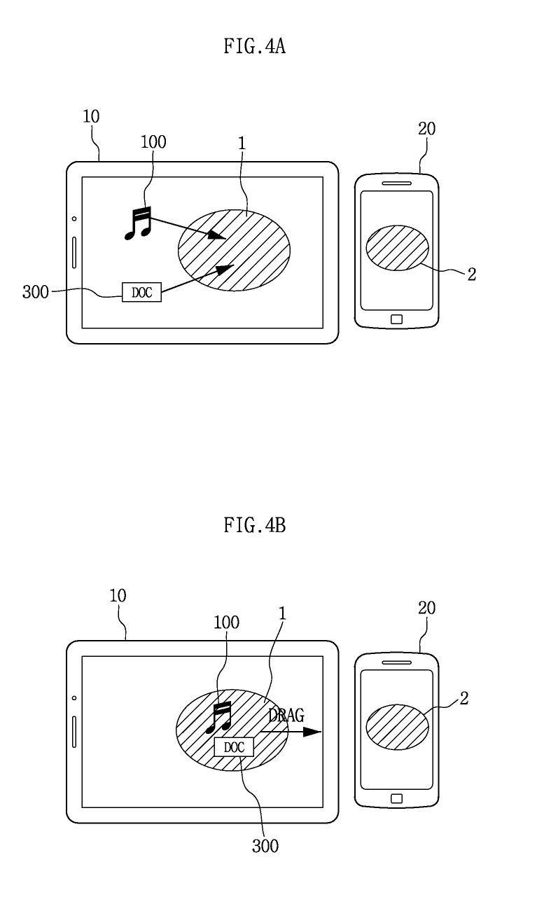

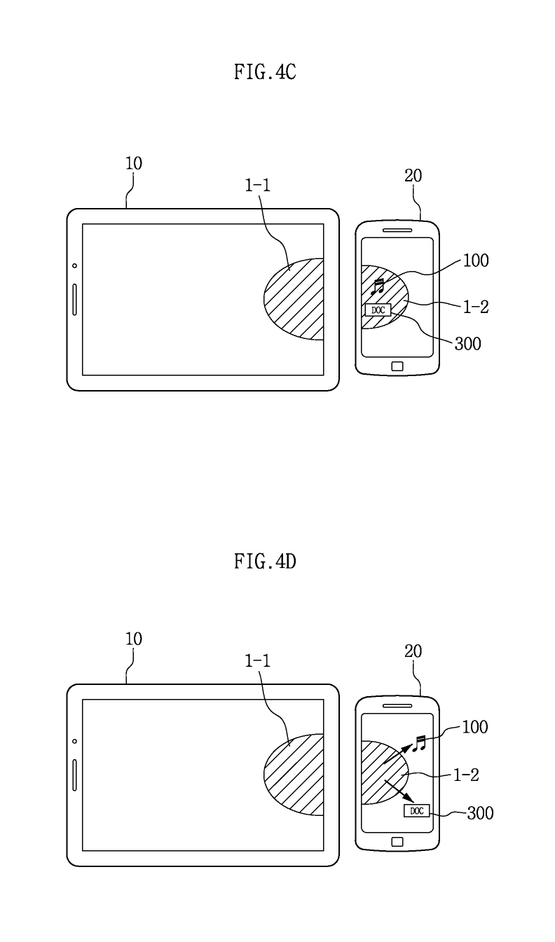

FIG. 2B is a flowchart illustrating an information transferring method of a mobile apparatus according to an exemplary embodiment of the present invention. FIG. 4A, FIG. 4B, FIG. 4C, and FIG. 4D are diagrams illustrating an information transfer process of a mobile apparatus according to an exemplary embodiment of the present invention. Operations S41, S42, S43, and S44 correspond to the operations S21, S22, S23, and S24 illustrated in FIG. 2A, respectively. In FIG. 2A, content is transmitted after a communication channel is set up. On the other hand, in FIG. 2B, content to be transmitted is selected, a communication channel is set up, and the content is transmitted. This will be described with reference to FIG. 4A, 4B, 4C, and 4D. As illustrated in FIG. 4A, content images 100 and 300 are dragged to a first connection image 1 (operation S45). Further, it may be verified whether a transmission of the contents is permitted before transmitting the contents (operation S46). The operation S46 may be the same as the operation S31 illustrated in FIG. 2A. As illustrated in FIG. 4B, the first connection image 1 in which the content images 100 and 300 are displayed may be dragged in a direction toward the second mobile apparatus 20 (operation S47). If the first connection image 1 is dragged toward the second mobile apparatus 20, the first mobile apparatus 10 requests the second mobile apparatus 20 to confirm a communication channel that may be set up (operation S48). The communication channel may include Near Field Communication, Bluetooth® 3.0, WI-FI Direct™, and Wireless USB, but is not limited thereto. If the second mobile apparatus 20 confirms a communication channel that may be set up (operation S49), the communication channel is set up through communication channel handshaking based on the device information, e.g., the communication profile information (operation S50). The content information is transferred to the second mobile apparatus 20 through the communication channel that has been set up (operation S51). The transmitted contents 100 and 300, as illustrated in FIG. 4C, may be displayed in the other part 1-2 of the first connection image displayed in the second mobile apparatus 20 or may be displayed in a part other than the other part 1-2 of the first connection image, as illustrated in FIG. 4D.

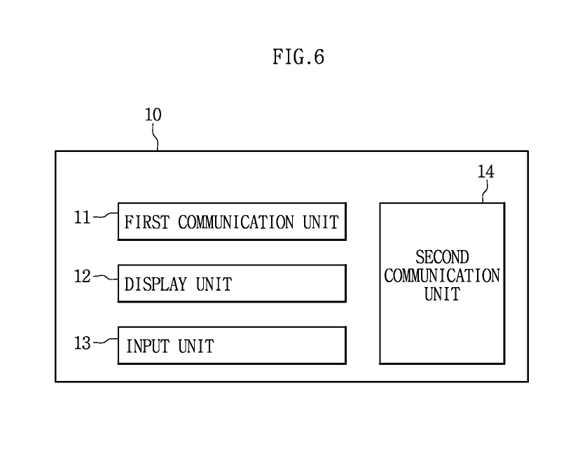

FIG. 6 is a diagram illustrating a configuration of a first mobile apparatus 10 according to an exemplary embodiment of the present invention. The mobile apparatus 10 may include a first communication unit 11, a display unit 12, an input unit 13, and a second communication unit 14. Further, the mobile terminal 10 may include one or more processors, e.g., application processor, image processor, video processor, and audio processor, one or more memories, a touch screen display, one or more sensors, modems, circuits, antennas, and the like. One or more modules or units may be stored on one or more memories and/or may include hardware to implement the operations described above.

The first communication unit 11 may receive the device information of an external device by communicating with the external device without a wired connection with the external device or being brought into contact therewith. For example, short range wireless communication technology may be used for the communication. The external device may include a second mobile apparatus 20, but is not limited thereto. The external device may include various types of devices that provide a communication interface with the first communication unit 11. The exchanged device information may include communication profile information, device feature information, and display setting information. The communication profile information is information of a profile that is used for communications, and the device feature information is device-specific information. The display setting information may include information that is used for a screen display, such as display resolution information, the number of pixels per inch, and the length of an adjoining face (inch). Near field communication (NFC) is a wireless type communication technology for very short-distance communications. If NFC is used for a communication protocol, data may be transmitted and received between mobile apparatuses within a short distance of 10 cm using a frequency band of 13.56 MHz. While general RFID reads information only in one way (unilateral communication), the NFC may transmit data in two ways (bilateral communication). Services that are based on the NFC tend to be applied to various fields, such as payment, authentication, mobile advertisements, electronic tickets, electronic name cards, and micro payment.

The display unit 12 may display various screens on the mobile apparatus 10. More specifically, the display unit 12 may display a graphic user interface, for example, a first connection image 1 determined in advance based on whether the device information of an external object has been received. If the device information of a second mobile apparatus 20 is received and the presence of the second mobile apparatus 20 within 10 cm is recognized, the display unit 12 may visually inform a user that content information may be transmitted by displaying the first connection image 1. If a user drags the first connection image 1 such that only a part of the first connection image 1 may be displayed on the display unit 12, e.g., at least portion of the boundary of the first connection image 1 is dragged across a screen boundary of the display unit 12 through a gesture of dragging the first connection image 1 to the side of the display unit 12, as illustrated in FIG. 4C, the display unit 12 displays the part 1-1 of the first connection image 1 that is not dragged out of the display unit 12. In such a case, the first communication unit 11 transmits the display setting information to the second mobile apparatus 20, so that the other part 1-2 of the first connection image 1 except the part 1-1 of the first connection image 1 is displayed in the second mobile apparatus 20. As the display unit 12, a light emitting diode (LED), an organic light emitting display (OLED), a light emitting polymer (LEP), an electro-luminescence (EL) element, a field emission display (FED), a polymer light emitting display (PLED), or the like may be used.

The input unit 13 may identify various inputs for the mobile apparatus 10. The input unit 130 may identify various touch and motion inputs for the mobile apparatus 10. As an example of the touch input, sensor inputs according to touches on the touch sensor may be identified (a single touch or a multi-touch may be performed), and the touch input may be a state, such as the position of a touched point, a new point, a moved point, or a released point or may be any one of various combinations of inputs made through touches, such as a tap, a double tab, panning, flicking, drag and drop, pinching, and stretching. Further, various motion inputs for tilting or shaking the mobile apparatus 10, an audio input, and the like may be an input for the mobile apparatus 10. The input unit 13 may identify and distinguish an input for the first connection image 1 displayed on the display unit 12.

The second communication unit 14 may transmit/receive contents to/from the second mobile apparatus 20. The second communication unit 14 may include NFC, Bluetooth®, Bluetooth® 3.0, WI-FI Direct™, and Wireless USB, but is not limited thereto. The second communication unit 14 sets up a communication channel with the second mobile apparatus 20 based on the communication profile information included in the device information of the second mobile apparatus 20. For example, information that is used for communications between wireless communication devices is acquired by using the communication profile information acquired through e.g., near field communication of the first communication unit 11. More specifically, when a part of the first connection image 1 is displayed on the display unit 12 due to an input of dragging the first connection image 1 in a direction toward the external object as illustrated in FIG. 4C, a communication channel is set up with the external object.

If content images 100, 200, and 300, each of which corresponds to the content information, is displayed on a part of the first connection image 1, the second communication unit 14 transmits the content information to the second mobile apparatus 20 through the communication channel that has been set up.

The second communication unit 14 may be set to a transmission mode in which content information is transmitted to the second mobile apparatus 20 in response to an input of touching the first connection image 1 and may be set to a reception mode in which content information is received from the second mobile apparatus 20 in response to an input of touching the second connection image 2. The transmission mode may be set as a master mode, and the reception mode may be set as a slave mode. Further, it may be configured such that, in the transmission mode, the first mobile apparatus 10 transmits information requesting for setting up the slave mode to the second mobile apparatus 20 through the first communication unit 11, and the second mobile apparatus 20 transmits slave mode confirming information to the first mobile apparatus 10.

The second communication unit 14 may request the second mobile apparatus 20 to confirm a communication channel that may be set up and set up a communication channel that has been confirmed. For example, if both a Bluetooth module and a Bluetooth 3.0 module are mounted in the first mobile apparatus 10, and only a Bluetooth module is mounted in the second mobile apparatus 20, the mounting of the Bluetooth module is checked only, and a communication channel through the Bluetooth module is requested.

The second communication unit 14 may check whether the content information is permitted to be transmitted and transmit the content information. For example, if digital rights management (DRM) is set in the content, a content producer may prohibit the replication of the is content so as to protect the copyright thereof. Further, a user may set a security setting for limiting the transmission of a specific content of the mobile apparatus 10. For data security purposes, it may be determined whether the transmission of content is permitted, and a permitted content may be transmitted if the authentication is successful.

Further, referring to FIG. 3A, the mobile apparatus 10 may recognize the mobile apparatus 20 if the mobile apparatus 20 is located in proximity to the mobile apparatus 10 based on a proximity sensor, a NFC module, and the like. If the NFC module is used, the mobile apparatus 10 and the mobile apparatus 20 may communicate with each other using the NFC module, and the mobile apparatuses 10 and 20 may determine that the mobile apparatuses 10 and 20 are located in proximity to each other when the communication using the NFC module is successful. If a proximity sensor is embedded in the mobile apparatus 10, the mobile apparatus 10 may recognize the mobile apparatus 20 using the proximity sensor. A Bluetooth® module may scan the mobile apparatus 20 according to a user instruction or periodically to recognize the mobile apparatus 20. If the mobile apparatuses 10 and 20 provide the Bluetooth® communication functions. Further, the mobile apparatus 10 may recognize the relative direction of the mobile apparatus 20 based on a direction sensor or a communication module. For example, the mobile apparatus 10 may utilize a communication module utilizing multiple reception points, such as multiple antennas, and may estimate a direction of a received wireless signal transmitted from the mobile apparatus 20 for estimating the direction of the mobile apparatus 20.

The mobile apparatus 10 may display a connection interface object. The connection interface object may include the first connection image 1 and the second connection image 2 shown in FIG. 3B to FIG. 3F, FIG. 4A to FIG. 4D, and FIG. 5A to FIG. 5B, but is not is limited thereto. The connection interface object may be a graphical user interface that enables transmission of data files deposited thereon using various types of wireless communication protocols as described above. The connection interface object may be displayed on a touch screen display of the mobile apparatus in response to an execution of an application icon associated with the connection interface object or the recognition of another mobile apparatus or other types of apparatus capable of a short range wireless communication supported by the mobile apparatus 10. If the connection interface object is selected, the mobile apparatus 10 may scan nearby communication devices using one or more communication protocols and may transmit a connection request to an identified device according to a compatible protocol. Further, the connection interface objects may be displayed on at least two mobile apparatuses if the communication channel among the mobile apparatuses has been established. The connection interface object may be displayed based on different settings and may be relocated, resized or reshaped by a touch input of a user. Further, more than one connection interface object may be displayed if multiple mobile apparatus are located in proximity to the mobile apparatus 10. Each connection interface object may be associated with a corresponding mobile apparatus. For example, if a first mobile apparatus establishes a channel with the mobile apparatus 10 via a first connection interface object, a second mobile apparatus may establish with a communication channel with the first mobile apparatus and the mobile apparatus 10 via the first connection interface object. Further, the second mobile apparatus may establish a communication channel with the mobile apparatus 10 via a second connection interface object. The second connection interface object may be split from the first connection interface object according to different settings. The connection interface object may include an indicator to distinguish the identity of the connected mobile apparatus and/or the communication protocol of the connection interface object. For example, the color or the shape of the connection interface object may indicate the established communication protocol associated with the connection interface object.

A user of the mobile apparatus 10 may associate a data file, an image or other types of data with the connection interface object by changing the screen of the mobile apparatus 10, selecting an object, e.g., a data file, and associating the selected object with the connection interface object. The connection interface object may be displayed on a different layer such that the connection interface object may be constantly displayed while changing the background screen image. The selected object may be deposited on the connection interface object by dragging the selected object into the connection interface object. If the object is deposited on, or received by the connection interface object, the received object may be transmitted to another mobile apparatus connected or interfaced via the connection interface object. A common short-range wireless communication channel may establish a wireless connection or a communication interface among connection interface objects. In another example, the received object may be transmitted to the other mobile apparatus if the user touches the connection interface object and relocates the connection interface object out of the screen of the mobile apparatus displaying the connection interface object by a flicking touch motion. The connection interface object may display the received data file therein, and may disappear from the screen of the mobile apparatus 10 according to the direction of the flicking touch motion. Then, the mobile apparatus 10 may transmit the data file to another mobile apparatus and redisplay the connection interface object without displaying the received data file therein to indicate the successful transmission of the data transmission. However, transmission, successful transmission, and failed transmission of the data file may be represented in any number of ways, for example, by differences in shading or transparency of the icon of the data file, representation of percentages or times of completion, and the like. Further, options may be provided upon successful and failed transmission, such as sending the data file to another device or resending the data file to the same device. The relocation and the redisplay of the connection interface object may be visually animated in a bounce back fashion, for example.

The connection interface object may display a screen image overlapped with the connection interface object. For example, the displayed web-browser, e.g., the Google® website, dragged in to the connection interface object may be displayed on a connection interface object of another mobile apparatus connected via the connection interface object. The user of the mobile apparatus 10 may copy and paste a text displayed in the connection interface object if another mobile apparatus shares a screen image including the text. It may provide a user interface of sharing text data without typing the text again for the sharing. For example, the website address, home address, telephone number, and the like may be shared with another mobile apparatus without typing the text. If a portion of a screen image of another mobile apparatus is transmitted to the mobile apparatus 10 via the connection interface object, text or other symbols included in the image may be transmitted to the mobile apparatus 10 as associated data to recognize the data corresponding to the text or symbols.

The above-described exemplary embodiments may be implemented in the form of a program command that can be executed through various constituent elements of a computer, and the program command may be recorded on a computer-readable recording medium. The above-described computer-readable recording medium may independently include a program command, a data file, a data structure, or the like or may include a combination thereof. The program command recorded on the computer-readable recording medium may be designed and configured especially for the present disclosure and may be known to those skilled in the art in the field of computer software so as to be usable. Examples of the computer-readable recording medium include a magnetic medium, such as a hard disk, a floppy disk, or a magnetic tape; an optical recording medium, such as a CD-ROM or a DVD; a magneto-optical medium, such as a floptical disk; and a hardware device, such as a ROM, a RAM, or a flash memory that is especially configured so as to store and execute the program command. Examples of the program command include not only a machine code that is produced by a complier but also a high-level language code that can be executed by a computer using an interpreter or the like. The above-described hardware device may be configured so as to operate as one or more software modules used for performing the process according to the present disclosure, and the program command may be implemented as one or more hardware devices.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A mobile apparatus, comprising:
a display to display a connection interface object in a first area of the display, the connection interface object connected with an external device, and to display a transferable object in a second area of the display, the connection interface object being configured to receive the transferable object;
an input unit to identify an input associated with the connection interface object displayed on the display; and
a communication unit to establish a wireless communication channel with the external device, and to transmit or receive data to or from the external device via the established wireless communication channel according to the input, the data comprising the transferable object received in the connection interface object.

2. The mobile apparatus of claim 1, wherein the communication unit receives device information of the external device, and
the connection interface object is displayed if the device information of the external device is received.

3. The mobile apparatus of claim 1, wherein the transferable object is received in the connection interface object in response to a touch input that drags the transferable object into the connection interface object.

4. The mobile apparatus of claim 1, wherein the transferable object comprises at least one of a web-browser image, web data included in a website, and data included in an executed application.

5. The mobile apparatus of claim 1, wherein the connection interface object is configured to be relocated according to a touch input associated with the connection interface object.

6. The mobile apparatus of claim 1, wherein the connection interface object of the mobile apparatus is connected with a connection interface object displayed on the external device when the wireless communication channel is established based on a short range wireless communication protocol between the mobile apparatus and the external device.

7. The mobile apparatus of claim 6, wherein the connection interface object of the mobile apparatus is configured to receive data of the external device received in the connection interface object displayed on the external device.

8. The mobile apparatus of claim 1, wherein the transferable object received in the connection interface object is transmitted to the external device according to a relocation of the connection interface object caused by a drag touch input on the connection interface object.

9. The mobile apparatus of claim 1, wherein the communication unit verifies the transferable object received in the connection interface object whether the received transferable object is permitted for transmission.

10. The mobile apparatus of claim 1, wherein the communication unit establishes the wireless communication channel with the external device if the connection interface object is relocated such that a portion of the connection interface object is not displayed on the display.

11. A method for transferring data via a connection interface object, the method comprising:
displaying the connection interface object connected with an external device in a first area of a display, and displaying a transferable object in a second area of the display, the connection interface object being configured to receive the transferable object;
identifying an input associated with the connection interface object displayed on the display;
establishing a wireless communication channel with the external device; and
transmitting or receiving data to or from the external device via the established wireless communication channel according to the input, the data comprising the transferable object received in the connection interface object.

12. The method of claim 11, further comprising:
receiving device information of the external device via a wireless communication with the external device,
wherein the connection interface object is displayed if the device information of the external device is received.

13. The method of claim 11, further comprising:
dragging the transferable object into the connection interface object in response to a touch input; and
depositing the transferable object in the connection interface object if the transferable object is dragged into the connection interface object.

14. The method of claim 11, further comprising:
dragging another transferable object received in the connection interface object out of the connection interface object; and
storing the other transferable object in a storage area of the mobile apparatus if the other transferable object is dragged out of the connection interface object.

15. The method of claim 11, wherein the transferable object comprises at least one of a web-browser image, web data included in a website, and data included in an executed application.

16. The method of claim 11, wherein the connection interface object is connected with a connection interface object displayed on the external device when the wireless communication channel is established based on a short range wireless communication protocol with the external device.

17. The method of claim 11, wherein the transferable object received in the connection interface object is transferable to the external device when the connection interface object is relocated such that a portion of the connection interface object is not displayed on the display.

18. A method for transferring data via a connection interface object, the method comprising:
displaying a first connection interface object and a transferable object on a display, the first connection interface object being configured to receive the transferable object and being connected with a second connection interface object displayed on an external device;
identifying an input associated with the first connection interface object displayed on the display;
establishing a short range wireless communication channel with the external device, the first connection interface object and the second connection interface object being connected by the short range wireless communication channel; and
transmitting or receiving data to or from the external device via the established short range wireless communication channel according to the input, the data comprising the transferable object and the transferable object being received in the first connection interface object from an area of the display or from the second connection interface object.

19. The method of claim 18, further comprising:
depositing the transferable object into the first connection interface object from the area of the display to transfer the transferable object to the second connection interface object.

20. The method of claim 18, further comprising:
displaying the transferable object in the first connection interface object if the transferable object is transferred from the second connection interface object; and
withdrawing the transferable object from the first connection interface object and storing the transferable object in a storage area in response to a touch input.
